(19) United States
(12) Patent Application Publication
(10) Pub. No.: US 2026/0311992 A1
(43) Pub. Date: Oct. 8, 2026

(54) METAL-CARBON NANOFIBER COMPOSITE ELECTRODES FOR HIGH PERFORMANCE LITHIUM-ION AND LEAD-ACID BATTERIES

(71) Applicants: Jonghyun Park, Rolla, MO (US); Hiep Pham, Rolla, MO (US)

(72) Inventors: Jonghyun Park, Rolla, MO (US); Hiep Pham, Rolla, MO (US)

(73) Assignee: The Curators of the University of Missouri, Columbia, MO (US)

(21) Appl. No.: 19/177,075

(22) Filed: Apr. 11, 2025

Related U.S. Application Data
(60) Provisional application No. 63/633,518, filed on Apr. 12, 2024.

(51) Int. Cl. H01M 4/04; D01D 5/00; D04H 1/4242; D04H 1/43; D04H 1/4382; D04H 1/728; D06C 7/04; H01M 4/02; H01M 4/1393; H01M 4/1395; H01M 4/22; H01M 4/56

(52) U.S. Cl. CPC H01M 4/0411; D01D 5/0038; D04H 1/4242; D04H 1/43; D04H 1/43835; D04H 1/728; D06C 7/04; H01M 4/0471; H01M 4/1393; H01M 4/1395; H01M 4/22; H01M 4/56; D10B 2321/10; D10B 2321/12; D10B 2505/00; H01M 2004/027

(57) ABSTRACT

The present disclosure is directed to a method for preparing a metal-carbon nanofiber composite material (e.g., lead-carbon nanofiber composite material). The method comprises electrospinning two solutions, wherein the first solution comprises a source of metal (e.g., lead) and the second solution comprises a carbon nanofiber precursor. The resulting fibers are heated to melt the metal (e.g., lead) onto the carbon nanofiber precursor fibers and form an intermediate fiber material. The intermediate fiber material is subjected to carbonization to form the metal-carbon nanofiber composite material. The metal-carbon nanofiber composite material may be used as an anode for a lead acid battery or lithium-ion battery.

### CROSS-REFERENCE TO RELATED APPLICATIONS

This application claims the benefit of U.S. Provisional Application No. 63/633,518, filed Apr. 12, 2024, the contents of which are incorporated herein in their entirety.

### FIELD

The present disclosure relates to methods for preparing a metal-carbon nanofiber composite material. In certain configurations, the metal component is lead. In particular, the method comprises electrospinning a first electrospinning solution and a second electrospinning solution onto the same surface to form a fiber material, heating the fiber material higher than the melting point of the polymer(s) in the solution(s), and carbonizing the fiber material to produce a metal-carbon (e.g., lead-carbon) nanofiber composite material.

### BACKGROUND

Composite materials containing metal particles attached to a nanostructured material, in which the metal particles are supported by the nanostructured substrate, feature unique and favorable properties that leverage the benefits of each individual component. These materials have been used for many applications, such as energy, chemical, and biomedical applications.

To prepare such composites materials, many methods have been employed to intimately attach metal particles to nanostructures. Such methods include chemical vapor deposition (CVD) and physical vapor deposition (PVD), which utilize active material particles within a carrier material. However, these methods are hindered by complex and lengthy manufacturing procedures, with production of insufficient amounts of final material. Further, such methods typically require a high material content to achieve a good performance by the resulting composite material (e.g., when used as an anode in a battery).

Conventional anode materials in lithium ion batteries, such as graphite or carbon, are known to have several significant limitations. These anodes typically have low capacity (e.g., 372 mAh/g), low current capability (translating to low power), and poor cyclability attributed to the low mechanical stability of graphite during battery operation.

To address the low current capability and stability issues, advanced carbon nanostructures, such as nanofibers, have been developed and composited with transition metals that exhibit high theoretical capacity but otherwise suffer from volume expansion-based degradation. Compositing transition metals with carbon is a common approach to suppress volume expansion and improve the stability of transition metal-based electrodes. For example, compositing Pb with carbon. Previous efforts have composited PbO and Pb-based materials with carbon by creating a carbon coating layer on Pb particle surface. However, the cycling stability is still low (e.g., <100 cycles). Other efforts in the field have not utilized carbon nanofibers with Pb and instead have focused on using other advanced carbon nanomaterials, such as graphene. These have been found to have significant limitations in terms of cost and complex processing.

Therefore, there remains a need in the art to develop new and improved methods for preparing composite metal-carbon materials such as lead-carbon nanofiber composite materials for use as an anode.

### BRIEF SUMMARY

One aspect of the present disclosure is directed to a method for preparing a metal-carbon nanofiber composite material (e.g., a lead-carbon nanofiber composite material). The method comprises providing a first solution comprising a source of metal and an acid, providing a second solution comprising a first polymer and a first solvent, and combining the first solution and second solution to form a first electrospinning solution. A second electrospinning solution is provided comprising a second polymer and a second solvent. The first electrospinning solution and second electrospinning solution are electrospun onto the same surface to produce a fiber material. The electrospinning operation comprises an extrusion needle and a voltage source adjacent to the tip of the needle. The fiber material is heated to a temperature greater than the melting point of the first polymer to produce an intermediate fiber material. Finally, the intermediate fiber material is carbonized to produce a metal-carbon nanofiber composite material.

Another aspect of the present disclosure is directed to a method as described above, wherein the metal is lead and the source of lead comprises lead oxide, the first polymer is polyvinylpyrrolidone (PVP), and the second polymer is polyacrylonitrile.

A further aspect of the present disclosure is directed to a method as described above, wherein the of lead comprises lead oxide, the first polymer is polyvinylpyrrolidone (PVP), the second polymer is polyacrylonitrile, and the resulting fiber material is heated to a temperature of at least about 300° C. to melt the PVP and polyacrylonitrile. Melting the PVP and polyacrylonitrile produces an intermediate fiber material wherein the electrospun fibers are sufficiently contacted with one another prior to carbonization.

A still further aspect of the present disclosure is directed to a lead acid battery or lithium-ion battery comprising an anode material comprising the described lead-carbon nanofiber composite materials.

Other objects and features will be in part apparent and in part pointed out hereinafter.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows an illustration of an electrospinning operation.

FIG. 2 shows a comparison of the results of electrospinning a PVP/PbO-only solution vs. the dual electrospinning of two solutions comprising PAN, PVP, and PbO onto the same surface.

FIG. 3 shows the impact of various furnace temperature ramp rates from 1° C./min to 5° C./min during the heating operation of an intermediate fiber material.

FIG. 4 illustrates the steps of one method of the present disclosure.

FIG. 5 shows a scanning electron microscope (SEM) image of a lead-carbon nanofiber composite material of the present disclosure.

FIG. 6 also shows a scanning electron microscope (SEM) image of a lead-carbon nanofiber composite material of the present disclosure.

FIG. 7 shows the elemental concentrations of O, C, and Pb in a lead-carbon nanofiber composite material of the present disclosure.

FIG. 8A illustrates thermogravimetric analysis (TGA) of pure carbon nanofiber.

FIG. 8B illustrates thermogravimetric analysis (TGA) of lead carbon nanofiber composites.

FIG. 9 reports the results of the specific capacity of a lead-carbon nanofiber composite material of the present disclosure when prepared as a pouch cell in a lead-acid battery.

FIG. 10 shows a performance comparison between a lead-carbon nanofiber composite material of the present disclosure and pure nanofiber cycling at 200 mA/g for a total of 250 cycles

FIG. 11 reports the cycling performance of various lead-carbon nanofiber composite materials of the present disclosure and pure nanofiber.

FIG. 12 reports the C-rate performance of various lead-carbon nanofiber composite materials of the present disclosure and pure nanofiber.

FIG. 13 illustrates the physical characteristics of various lead-carbon nanofiber composite materials of the present disclosure and pure nanofiber after the testing of FIG. 11 and FIG. 12.

FIG. 14 reports the results of a cyclic-voltammetry analysis of various lead-carbon nanofiber composite materials of the present disclosure and pure nanofiber.

FIG. 15 reports the results of electrochemical impedance spectroscopy (EIS) analysis of various lead-carbon nanofiber composite materials of the present disclosure and pure nanofiber.

Corresponding reference characters indicate corresponding parts throughout the drawings.

### DETAILED DESCRIPTION

The present disclosure is directed to a method for preparing a metal-carbon nanofiber composite material (e.g., a lead-carbon nanofiber composite material). In further aspects, the metal-carbon nanofiber composite material may be used in lithium-ion or lead-acid batteries. For example, as an anode.

Traditional methods such as chemical vapor deposition (CVD) and physical vapor deposition (PVD) have been previously used to prepare composites. These methods create metal particles attached to nanostructures and utilize active material particles within a carrier material. However, these methods are limited by their complex and lengthy manufacturing procedures and relatively low amount of resulting composite material. Carbon nanofibers have been investigated and composited with various transition metals. The use of transition metals imparts a higher theoretical capacity than carbon materials alone. For example, of the several transition metals, lead (Pb) shows significant promise due to its high theoretical capacity (582 mAh/g) coupled with its high availability and low cost. However, the resulting materials typically suffer from volume expansion-based degradation during use, due to the high volume expansion associated with lithium intercalation and deintercalation into transition metal materials. In attempts to create a layer of carbon coating on a transition metal, the cycling stability was found to be much lower than would be commercially acceptable.

In lead-acid batteries, PbO₂ is conventionally used as the cathode material. However, the slow kinetics of conventional PbO₂-based cathodes limits the rate performance for lead-acid batteries. Compositing the cathode with carbon-based materials can help to improve the performance. However, the conventional laminated structure of the cathode still leads to an overall poor performance. One of the key challenge in utilizing PbO and Pb-based materials for both lithium-ion batteries and lead-acid batteries is its high volume expansion during cycling (up to 400%) which limits its stability.

The inventors of the present disclosure have discovered a new and improved method for preparing composite materials. The so-called “chemical melting deposition” (CMD) of the present disclosure, solves the challenges with existing methods and allows for the creation of nanoparticle-nanofiber composite structures with high particle loading, high yield, and facile procedure. By anchoring metal (e.g., PbO) materials into carbon nanofiber, the volume expansion can be greatly mitigated due to the intrinsic nature of the carbon nanofiber shape. This, in turn, yields high capacity and a highly stable metal/C (e.g., PbO/C) electrode which can be operated at high current.

In one embodiment of the present method, two solutions are electrospun onto the same surface. Fiber materials are formed on the surface from the electrospinning operations. The resulting fibers are subjected to a heating operation to “melt” and prepare an intermediate fiber material. The intermediate fiber material is then calcined in a calcination step.

In another embodiment, two distinct solutions are electrospun onto the same surface. The first solution comprises lead oxide particles in a sacrificial polymer carrier (i.e. first polymer). The second solution comprises a carbon nanofiber polymer precursor (i.e. second polymer). After electrospinning the two solutions, fiber materials are formed on the surface. The resulting fibers are subjected to a heating operation, at a temperature greater than the melting point of the first polymer, to melt the first polymer. The heating operation heats the fibers to a temperature greater than the melting point of the first (sacrificial) polymer, which results in a transfer of the lead oxide particles onto the carbon nanofiber precursor fibers. In certain embodiments, this melting operation creates an intimate contact between the lead oxide particles and the carbon nanofiber precursor. The intermediate fiber material produced from this heating operation is then subjected to carbonization to carbonize the precursor polymer fibers and form carbon nanofibers having lead oxide particles anchored or fused thereon.

Unlike prior methods, the present method utilizes melting of carrier fibers (i.e. lead oxide fibers) adjacent to the target fibers (i.e. carbon nanofiber precursor fibers) to transfer and anchor/fuse particles and create the nanofiber-nanoparticle composite. The efficacy of the final composite material is demonstrated by testing as a lithium ion battery anode. It was surprisingly discovered that the issue of volume expansion-induced mechanical degradation exhibited by transition metal materials such as Pb is mitigated by the effective anchoring/fusion of the metal to carbon nanofibers. Through combination of a dual electrospinning step with subsequent thermal treatment, metal particles (e.g., PbO) can be effectively anchored to carbon nanofiber, preventing its rapid degradation during battery cycling. Compared to similar works, this approach is facile, enabling non-complex manufacturing of a highly stable anode with higher capacity than the conventional graphite anode material.

Therefore, the metal-carbon nanofiber composite material described herein is generally prepared by three steps. Although discussed herein with respect to lead, it will be understood that the process is equally applicable to other metals (e.g., transition metals). A first step comprises a dual extrusion-based electrospinning technique. This is followed by a thermal treatment step wherein chemical melting deposition (CMD) occurs. Finally, carbonization of the resulting material is undertaken to form a lead-carbon nanofiber composite material.

In the dual extrusion-based electrospinning, two electrospinning solutions are prepared, one to deliver the source of lead (e.g., PbO particles) in a sacrificial (first) polymer carrier and the other for the carbon nanofiber precursor polymer solution.

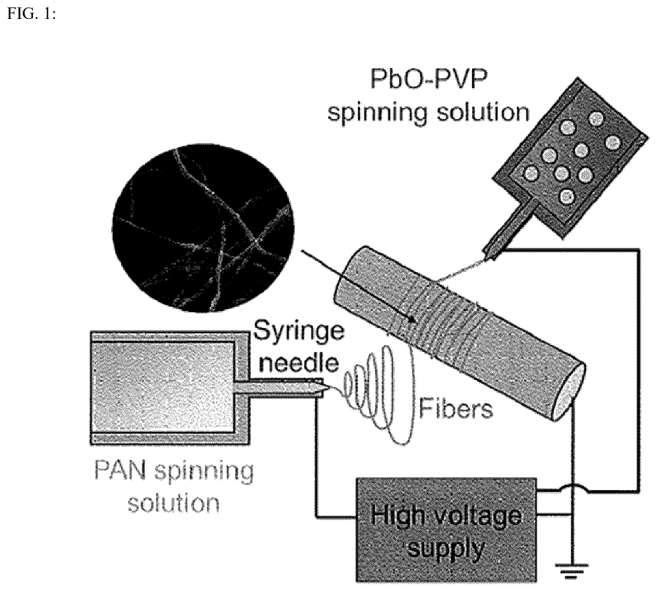

In one embodiment, the two electrospinning solutions are placed into separate syringes, and then placed on opposite sides of a rotating drum collector, which serves as the substrate for fiber deposition and collection. The drum collector may optionally have a coating thereon to make the removal of the electrospun solutions easier. For example, the drum collector may have an aluminum foil coating. The solutions are extruded from the syringes at the same volumetric rate by a syringe pump. A high voltage (e.g., 15-20 kV) is typically connected to the syringe needle tips. This ensures that the solutions are extruded, nanofibers are formed and collected on the drum collector. An illustration of an example of electrospinning operation is shown in FIG. 1.

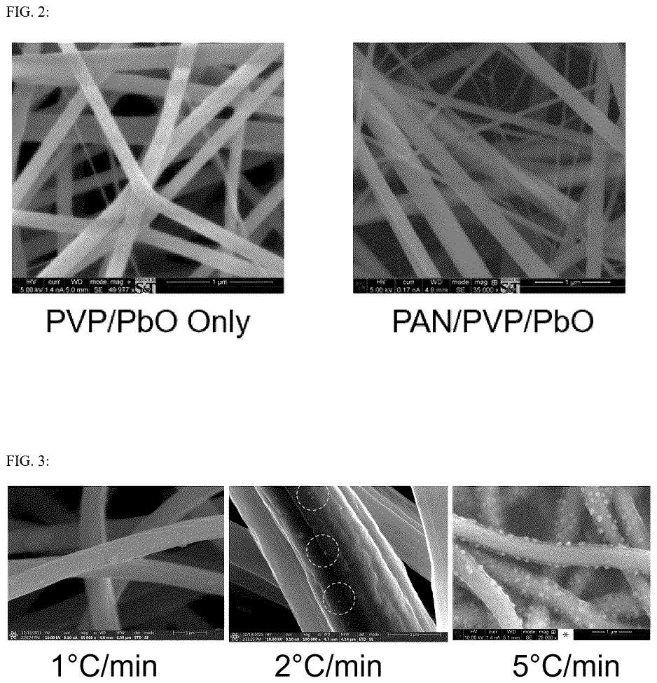

Electrospinning two distinct solutions allows for a more intimate mixing of the resulting fibers. This provides significant benefits when heating the fibers to melt the first (sacrificial) polymer and deposit lead onto the surface of the fiber having carbon nanofiber precursor polymer therein. The closer these two electrospun fibers are to one another prior to sacrificing of the first polymer, the more likely that lead will be deposited on the surface of the fiber having carbon nanofiber precursor polymer therein. FIG. 2 shows the electrospinning results of the first electrospinning solution (PVP/PbO Only) as compared to the dual electrospinning of both electrospinning solutions (PAN/PVP/PbO) onto the same surface.

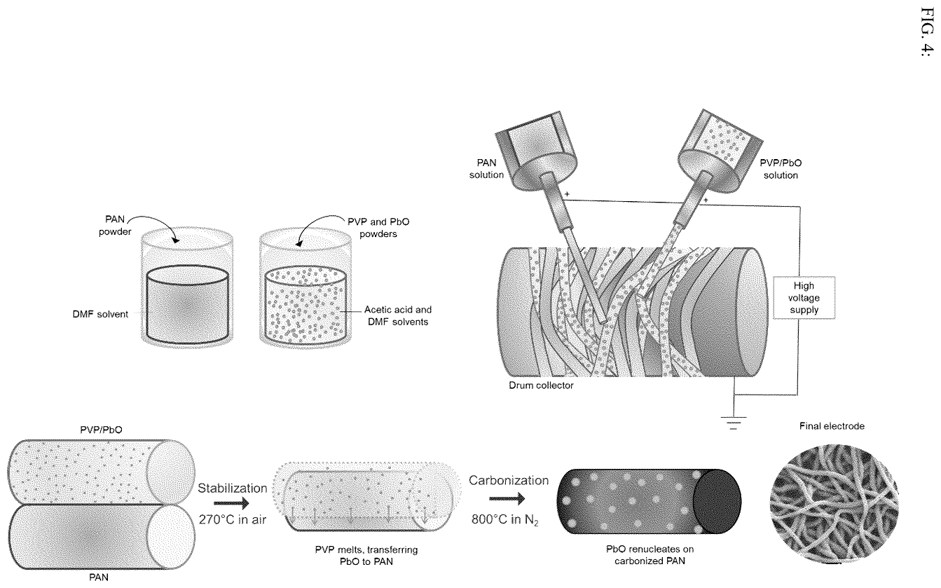

After the electrospinning operation, the resulting fibers are peeled from the aluminum foil and transferred into a furnace for the thermal treatment process (i.e. heating/melting operation). The furnace is first held at a low stabilization temperature for a few hours in air. During this stabilization, initial melting of the sacrificial polymer (i.e. first polymer) occurs. This results in a transferring of the dissolved PbO particles onto the target carbon nanofiber precursor fibers and formation of an intermediate fiber material. The furnace is then slowly ramped up to the carbonization temperature as nitrogen is flushed through the furnace to carbonize the intermediate fiber material and produce the lead-carbon nanofiber composite material. FIG. 3 shows the impact of various furnace temperature ramp rates from 1° C./min to 5° C./min. PbO particle deposits can be clearly seen in the 5° C. rate sample, and are circled with a dotted line in the 2° C. sample.

Carbonization is thought to provide several benefits. During carbonization, complete evaporation of the remaining sacrificial polymer material occurs. Since the remaining sacrificial polymer is removed, the PbO particles (i.e. metal particles) are fully transferred and precipitated onto the carbon nanofiber precursor fibers. This creates an intimate contact between the PbO particles (i.e. metal particles) and carbon nanofiber precursor fibers. Finally, the carbonization temperatures result in the carbonization of the intermediate fiber material to form carbon nanofibers with PbO particles (i.e. metal particles) anchored and/or fused thereon (i.e. the lead-carbon nanofiber composite material).

The materials used in the method of the present disclosure are generally selected such that the method results in carbon nanofibers having metal (e.g., PbO) anchored and/or fused thereof. It will be understood that certain components may not effectively mix or may negatively interact when used in the method together. Therefore, the method may comprise two or more electrospinning operations wherein each operation utilizes a different electrospinning solution.

For example, in one embodiment, a first electrospinning solution is designed to deliver the metal particle (e.g., PbO) and a second electrospinning solution is designed to carry a carbon nanofiber precursor polymer. One carbon nanofiber precursor polymer, polyacrylonitrile (PAN), is generally understood to be incompatible with solvents or other components that may be used to dissolve PbO and prepare a lead-containing electrospinning solution. For example, PAN is generally incompatible (e.g., insoluble) with acetic acid and will results in a solution that is unextrudable. Therefore, the electrospinning operations may comprise the distinct first and second electrospinning solutions.

In one embodiment, a first electrospinning solution is prepared comprising the metal particle (e.g., PbO), acetic acid, polyvinylpyrrolidone (PVP), and optional solvents. A second electrospinning solution is prepared comprising PAN and optional solvents. The solvents of the first and second electrospinning solutions may be the same or different. The electrospinning solutions are then separately electrospun onto a surface. The method otherwise progresses as described elsewhere herein. By separately electrospinning two solutions, it is possible to utilize incompatible components (e.g., PAN and acetic acid) while still achieving the desired goal of preparing a lead-carbon nanofiber composite material.

Further, it may be desirable to electrospin two distinct solutions so that the carbon nanofiber precursor polymer (i.e. second polymer) and the source of metal (e.g., lead) do not mix prior to heating/carbonization. Utilizing a second polymer with a high carbon content (such as PAN) in a distinct second electrospinning solution enables efficient conversion to carbon nanofibers. However, if this second polymer were to be included in the metal-containing solution, the second polymer may inhibit the metal “melting” (i.e. the evaporation of the first polymer and transfer and precipitation of the metal particles onto the carbon nanofiber precursor fibers). Ultimately, this may lower the overall dispersion of the metal particle onto the carbon nanofiber. In one embodiment, it is desirable to use a first polymer with a lower melting point and lower carbon content to facilitate the chemical melting deposition (CMD) method, while using a higher carbon content polymer as the second polymer in the second electrospinning solution.

As described above, in certain methods of the present disclosure, a first electrospinning solution comprising a source of the metal component (e.g., lead) may be prepared. The source of metal particle may be combined with other components to form the first electrospinning solution comprising the source of lead. For example, the first electrospinning solution may comprise a sacrificial polymer (i.e. first polymer), acid, and/or solvent (i.e. first solvent).

The source of metal for use in the first electrospinning solution may be any source of metal that is suitable for eventual electrospinning. For example, the source of metal may be metal oxides, carbonates, sulfates, hydroxides, etc., In one embodiment, the source of lead may be a lead oxide. For example, lead monoxide. In other embodiments, the source of lead may be a lead carbonate or a lead hydroxide.

One or more acids may be combined with the source of metal to form the first electrospinning solution. The acid may be any acid suitable for combination with lead to form a solution. In some embodiments, the acid may be a strong acid. For example, a strong acid selected from the group consisting of chloric acid, hydrobromic acid, hydrochloric acid, hydroiodic acid, nitric acid, perchloric acid, sulfuric acid, and combinations thereof. Strong acids are typically used for dissolving sources of metals, such as lead. However, strong acids may not always be suitable for electrospinning operations, because there is a risk of volatilizing the strong acid. A volatilized strong acid may present serious safety risks. Therefore, in certain embodiments, an acid that dissolves the source of lead but is not a strong acid may be used. Alternatively, an acid may be selected based upon whether lead is soluble in the acid. For example, acetic acid fulfils both of these requirements.

In certain embodiments, the first electrospinning solution may also comprise a sacrificial polymer (i.e. first polymer). As described elsewhere herein, in certain embodiments, it may be desirable to electrospin a metal-containing solution wherein the resulting fibers may be heated to volatilize certain components and “melt” the metal particles from the fibers onto a second surface (e.g., onto carbon nanofibers).

In one embodiment, the sacrificial polymer (i.e. first polymer) may be any polymeric material that volatilizes or degrades (e.g., melts) at a temperature lower than the carbon nanofiber precursor polymer used in the method. For example, the first polymer may have a melting point lower than the melting point of polyacrylonitrile (PAN).

In certain embodiments, the first polymer may have a melting point of about 450° C. or lower, about 400° C. or lower, about 350° C. or lower, about 300° C. or lower, about 250° C. or lower, about 200° C. or lower, about 150° C. or lower, about 100° C. or lower, or about 50° C. or lower. For example, from about 50° C. to about 450° C., from about 50° C. to about 400° C., from about 50° C. to about 350° C., from about 50° C. to about 300° C., from about 50° C. to about 250° C., from about 50° C. to about 200° C., or from about 50° C. to about 150° C.

In other embodiments, it may be desirable to select a first polymer having a low carbon content. Without being bound to the theory, it is believed that a lower carbon content polymer facilities “melting” of the metal (e.g., lead) particles from the electrospun fibers onto the second surface (e.g., onto carbon nanofibers). For example, in some embodiments, the first polymer may have an overall carbon content (i.e. molecular mass of the total polymer) of about 65% or less, about 60% or less, about 55% or less, about 50% or less, about 45% or less, about 40% or less, about 35% or less, about 30% or less, about 25% or less, or about 20% or less.

In certain embodiments, the first polymer is selected from the group consisting of synthetic polymers, such as polyvinyl alcohol, polyvinyl acetate, polyethylene oxide, polyvinyl ether, polyvinylpyrrolidone, polyglycolic acid, polyvinylidene difluoride, polyacrylonitrile, polyacrylic acid, polymethylmethacrylate, and combinations thereof. In one embodiment, the first polymer is polyvinylpyrrolidone (PVP).

In certain embodiments, the first electrospinning solution may also comprise a first solvent. The first solvent should be selected such that the solvent is compatible with the other materials of the first electrospinning solution and does not prevent the first electrospinning solution from being extruded in an electrospinning operation.

In certain embodiments, the first solvent is any solvent that is able to dissolve the first polymer without dissolving the second polymer. In one embodiment, the first solvent is dimethylformamide (DMF).

The first electrospinning solution may be prepared using any number of orders of addition. In one embodiment, a first solution is prepared comprising the source of metal and acid, a second solution is prepared comprising the first polymer and first solvent, and the first and second solutions are combined to form the first electrospinning solution. In another embodiment, the first polymer and source of metal are combined to form a first solution, the acid and first solvent are combined to form a second solution, and the first and second solutions are combined to form the first electrospinning solution. In still further embodiments, each component may be added step-wise.

As described above, a second electrospinning solution comprising a carbon nanofiber precursor polymer (i.e. second polymer) may be prepared. In certain embodiments, the second electrospinning solution may comprise further components. For example, a solvent.

The carbon nanofiber precursor polymer (i.e. second polymer) may be any polymer that is suitable for preparing a carbon nanofiber. The second polymer should be selected such that efficient conversion to a carbon nanofiber may be achieved.

In certain embodiments, the second polymer is a polymer having a high carbon content. For example, in some embodiments, the second polymer has an overall carbon content (i.e. molecular mass of the total polymer) of about 50% or greater, about 55% or greater, about 60% or greater, about 65% or greater, about 70% or greater, about 75% or greater, or about 80% or greater. For example, from about 50% to about 80%, from about 50% to about 75%, from about 55% to about 75%, from about 60% to about 75%, or from about 65% to about 70%.

In some embodiments, the second polymer is a polymer having a high melting point. For example, a melting point of about 150° C. or greater, about 200° C. or greater, about 250° C. or greater, about 300° C. or greater, about 350° C. or greater, about 400° C. or greater, about 450° C. or greater, or about 500° C. or greater. In one embodiment, the second polymer has a melting point of from about 150° C. to about 500° C., from about 200° C. to about 500° C., from about 250° C. to about 500° C., or from about 300° C. to about 500° C.

In some embodiments, the second polymer is selected from any polymer that is suitable for use as a carbon nanofiber precursor. In certain embodiments, the second polymer is selected from the group consisting of natural or synthetic polymers, such as polyvinyl alcohol, polyvinyl acetate, polyethylene oxide, polyvinyl ether, polyvinylpyrrolidone, polyglycolic acid, polyvinylidene difluoride, polyacrylonitrile, polyacrylic acid, polymethylmethacrylate, and combinations thereof. In one embodiment, the second polymer is polyacrylonitrile (PAN).

In certain embodiments, the second electrospinning solution may also comprise a second solvent. The second solvent should be selected such that the solvent is compatible with the other materials of the second electrospinning solution and does not prevent the second electrospinning solution from being extruded in an electrospinning operation.

In certain embodiments, the second solvent is any solvent that is able to dissolve the second polymer without dissolving the first polymer. In one embodiment, the second solvent is dimethylformamide (DMF).

In some embodiments, the second solvent is the same as the first solvent. In other embodiments, the second solvent is different than the first solvent.

The first electrospinning solution and second electrospinning solution are separately subjected to an electrospinning operation. Electrospinning generally comprises extruding a solution from a needle tip, with the application of sufficiently high voltage, to form electrospun fibers on the electrospinning surface. For example, as shown in FIG. 1, a high voltage supply is attached to the extruding needle tip, fibers are extruded from the tip, and the fibers collect on the cylindrical electrospinning surface.

The voltage applied during the electrospinning process directly influences the formation of fibers. The voltage must be sufficiently high enough to eject the extruded solution from the needle/nozzle to form the fibers. Lower voltages may create a combination of electrospraying and electrospinning, each of which form entirely different products, or fail to form fibers at all. Higher voltages tend to fragment the ejected fibers due to the aggressive forces generated, as well as impact the final quality of the fibers. Furthermore, as the voltage directly affects the rate at which a solution can be “converted” into fibers, the voltage affects the fiber diameter. Lower voltages may create larger diameter fibers. Conversely, higher voltages may create smaller diameter fibers.

In certain embodiments, the electrospinning process(es) may utilize a voltage of from about 10 kV to about 50 kV, from about 10 kV to about 45 kV, from about 10 kV to about 40 kV, from about 10 kV to about 35 kV, from about 10 kV to about 30 kV, from about 15 kV to about 30 kV, or from about 15 kV to about 25 kV.

The rate at which an electrospinning solution is extruded at through the needle/nozzle is also thought to impact the resulting fiber quality. A sufficient supply of the solution is required to continuously form the fibers during the process. A low flowrate may not supply enough of the solution to be ejected through a needle/nozzle, leading to fragmented fibers, as well as technical challenges such as needle/nozzle clogging, which inhibit the formation of fibers. A high flowrate may not be able to be extruded efficiently into fibers via the voltage, where large droplets may begin to form at the needle/nozzle tip and create a combined electrospraying and electrospinning effect, as well as impede the continuous formation of fibers due to dripping.

In certain embodiments, the electrospinning process(es) may utilize a flowrate of from about 0.1 mL/hr to about 10 mL/hr, from about 0.1 mL/hr to about 9 mL/hr, from about 0.1 mL/hr to about 8 mL/hr, from about 0.1 mL/hr to about 7 mL/hr, from about 0.1 mL/hr to about 6 mL/hr, from about 0.1 mL/hr to about 5 mL/hr, from about 0.1 mL/hr to about 4 mL/hr, from about 0.1 mL/hr to about 3 mL/hr, from about 0.1 mL/hr to about 2 mL/hr, from about 0.1 mL/hr to about 1 mL/hr, from about 0.2 mL/hr to about 1 mL/hr, from about 0.3 mL/hr to about 1 mL/hr, from about 0.4 mL/hr to about 1 mL/hr, or from about 0.5 mL/hr to about 1 mL/hr.

Finally, the temperature at which a solution is ejected may be an important consideration in the electrospinning process(es). Due to the presence of active materials in the spinning solution, it is important the electrospinning solution does not contain large particles that would block the needle/nozzle. The temperature of the electrospinning solution affects the solubility of the active material in the electrospinning solution, which in turn affects the spinnability of the solution into fibers. At lower temperatures, and depending on the saturation of the solution, the active material in the solution may begin to reprecipitate into larger, solid particles that impede the flow of the solution as the particles agglomerate closer to the needle/nozzle. A higher temperature may begin to degrade the solution by facilitating unwanted reactions. Furthermore, the temperature affects the drying of the fibers during the fiber ejection from the needle/nozzle and as the fiber is collected onto the surface. Insufficient drying caused by lower temperatures may cause fiber fusion as residual solvents on the fiber surface are not effective evaporated during the spinning. Higher temperatures may accelerate the fiber drying but can affect the final fiber quality in terms of cracking and brittleness. Temperatures should be adjusted based on the materials that are involved in the spinning solution. In certain configurations, the electrospinning temperature is about 50° C.

In certain embodiments of the present disclosure, the surface onto which the first electrospinning solution and second electrospinning solution are electrospun is a cylinder. In some embodiments, the surface is rotated during the electrospinning operation in order to cover the surface with fibers. In a still further embodiment, the first electrospinning solution and second electrospinning solution are simultaneously extruded onto the same surface. In another embodiment, the first electrospinning solution and second electrospinning solution are simultaneously extruded onto a rotating cylindrical surface.

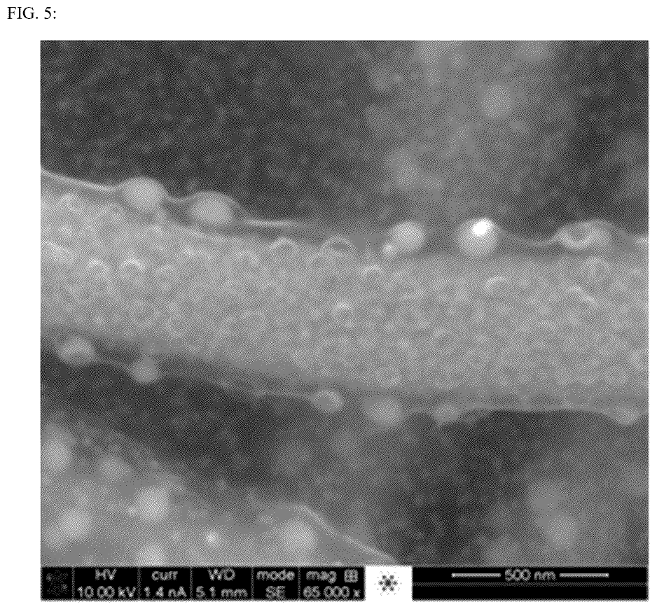

In certain embodiments, the first electrospinning solution and second electrospinning solution may be extruded onto different portions of the surface (e.g., as shown in FIGS. 1 and 4), such that when the surface rotates a relatively uniform coating of first and second electrospinning solution fibers are present along the surface. This relatively uniform coating may be important for preparing a metal-carbon nanofiber composite material. For example, as described in further detail herein, the metal-carbon nanofiber composite material may be formed by “melting” the first electrospinning solution components (i.e. lead particles) onto the second electrospinning solution fibers (i.e. containing carbon nanofiber precursor polymers). By ensuring a relatively uniform coating of the two fiber materials, the resulting lead-carbon nanofiber composite material may also be more uniform.

In other embodiments, the first electrospinning solution and second electrospinning solution may be electrospun separately. The resulting fibers may then be placed onto each other for the subsequent heating and carbonization steps. However, this process may result in a less intimate contact between the fibers, which may ultimately impact the ability of the metal particles to melt and embed on the fiber comprising the carbon fiber precursor polymer.

In some embodiments, electrospinning the first and second electrospinning solutions entails utilizing a 1:1 volumetric ratio of the first and second electrospinning solutions. In other embodiments, the electrospinning step comprises electrospinning a volumetric ratio of first to second electrospinning solution of from about 10:1 to about 1:10, from about 9:1 to about 1:9, from about 8:1 to about 1:8, from about 7:1 to about 1:7, from about 6:1 to about 1:6, from about 5:1 to about 1:5, from about 4:1 to about 1:4, from about 3:1 to about 1:3, or from about 2:1 to about 1:2.

The melting or heating step of the method of the present disclosure requires heating the fiber material on the electrospinning surface (i.e. a combination of fibers from the first electrospinning solution and second electrospinning solution) to a temperature sufficient to volatilize (e.g., melt) the sacrificial (first) polymer.

For example, in some embodiments, the fiber material is heated to a temperature of about 100° C. or greater, about 150° C. or greater, about 200° C. or greater, about 250° C. or greater, about 300° C. or greater, about 350° C. or greater, about 400° C. or greater, about 450° C. or greater, about 500° C. or greater, about 550° C. or greater, or about 600° C. or greater.

In certain embodiments, the fiber material is heated to a temperature between the melting point of the first polymer and the melting point of the second polymer.

For example, in some embodiments, the fiber material is heated to a temperature of from about 100° C. to about 600° C., from about 150° C. to about 600° C., from about 200° C. to about 600° C., from about 250° C. to about 600° C., from about 250° C. to about 550° C., from about 250° C. to about 500° C., from about 250° C. to about 450° C., from about 250° C. to about 400° C., or from about 250° C. to about 350° C.

After the heating or melting step, an intermediate fiber material is produced wherein lead is present on the carbon nanofiber precursor polymer fibers. In certain embodiments, lead particles are present on the carbon nanofiber precursor polymer fibers.

The intermediate fiber material is then subjected to a carbonization step to carbonize the nanofiber precursor polymer fibers and produce the lead-carbon nanofiber composite material. The carbonization results in the metal (e.g., PbO particles) being anchored or fused to the resulting carbon nanofibers to form the lead-carbon nanofiber composite material.

In certain embodiments, the carbonization is conducted at a temperature of about 500° C. or greater, about 600° C. or greater, about 700° C. or greater, about 800° C. or greater, about 900° C. or greater, about 1,000° C. or greater, about 1,100° C. or greater, about 1,200° C. or greater, about 1,300° C. or greater, about 1,400° C. or greater, or about 1,500° C. or greater.

In other embodiments the carbonization is conducted at a temperature of from about 400° C. to about 2,000° C. , from about 500° C. to about 2,000° C., from about 600° C. to about 2,000° C. , from about 700° C. to about 2,000° C. , from about 800° C. to about 2,000° C. , from about 900° C. to about 2,000° C. , or from about 1,000° C. to about 2,000° C.

In certain embodiments, the carbonization is conducted in an inert environment. For example, in a nitrogen purged environment.

In some embodiments, the heat within the heating compartment or furnace in which the intermediate fiber material is carbonized is gradually raised. For example, in some embodiments, the furnace is ramped to the carbonization temperature at a rate of about 1° C./min, about 2° C./min, about 3° C./min, about 4° C./min, about 5° C./min, about 10° C./min, about 15° C./min, about 20° C./min, or about 25° C./min. In one embodiment, the furnace is ramped to the carbonization temperature at a rate of about 5° C./min.

In some embodiments, the intermediate fiber material may be heated at the carbonization temperature for a period of time. For example, for a period of about 15 minutes or greater, about 30 minutes or greater, about 45 minutes or greater, about 1 hour or greater, about 2 hour or greater, about 3 hour or greater, about 4 hour or greater, or about 5 hour or greater.

The above-described method, and components used in preparing the lead-carbon nanofiber composite material, may provide an additional benefit of being more cost effective than prior known methods. The materials (e.g., PVP, PAN, DMF, etc.) may be readily available and relatively low cost. Further, the materials are selected such that the electrospinning solution(s) can be easily extruded without the need for complex handling procedures. That is, the materials are such that traditional electrospinning equipment may be employed. Further, as described above, the materials may be selected to have properties such that the heating step and/or carbonization step can be carried out at heat and energy requirements that are not commercially prohibitive.

In certain embodiments, the metal-carbon nanofiber composite material of the present disclosure may be used as an anode or cathode component of a battery. For example, lead-carbon nanofiber composite material may be used as an anode of a lead acid battery or lithium-ion battery. In other embodiments, at least a portion of the anode or cathode of a lead acid battery or lithium-ion battery may comprise the metal-carbon nanofiber composite material of the present disclosure.

As discussed above, and in further detail in the Examples, the metal-carbon nanofiber composite material of the present disclosure may be particularly suited to be an anode or cathode. Lead-carbon nanofiber composite materials were particularly found to exhibit less volume expansion-based degradation (i.e. expansion of the volume of the material, resulting in wear and damage over time).

All battery electrode materials naturally undergo some degree of volume change during the cycling process, where Li ions insert and deinsert to and from electrodes. The ultimate consequences resulting from volume expansion depend on the material's mechanical properties and its ability to withstand the volume change without cracking. Cracking leads to discontinuity in the contact between active material particles (poor charge transport), loss of active materials (loss in capacity), and the facilitation of irreversible side reactions upon contact of the electrolyte with the “fresh” surfaces created/exposed due to the formation of cracks (affecting charge transport and diminishing capacity). If the material's mechanical property can permit repeated volume expansion and contraction without fracturing or otherwise damaging the material, considerable benefits can be realized. Similarly, significant benefits (e.g., increased longevity) can be achieved if the extent of the volume expansion and contraction can be minimized.

In certain embodiments where the metal-carbon nanofiber composite material (e.g., lead-carbon nanofiber composite material) of the present disclosure is formed as an anode, after about 50 or more cycles, about 100 or more cycles, about 150 or more cycles, or about 200 or more cycles at 200 mA/g the volume of the lead-carbon nanofiber composite material anode is about 150% or less, about 125% or less, about 120% or less, about 115% or less, about 110% or less, about 105% or less, or about 100% or less of the volume of the lead-carbon nanofiber composite material anode prior to the first cycle. Previously known anode materials have exhibited volume expansion of greater than 200% of the original volume. Therefore, the metal-carbon nanofiber composite material of the present disclosure provides considerable benefits when formed as an anode of a battery.

Another measure of the durability and longevity of the material can be determined by reference to the ability of the material to maintain overall capacity. All anode materials will exhibit decreased capacity over time. However, if the rate of degradation of capacity retention can be minimized, then the materials will maintain a longer useful life.

In some embodiments where the metal-carbon nanofiber composite material of the present disclosure is formed as an anode, the metal-carbon nanofiber composite material anode maintains about 25% or greater, about 30% or greater, about 35% or greater, about 40% or greater, or about 45% or greater of its capacity after about 50 or more, about 100 or more, about 150 or more, or about 200 or more cycles at 200 mA/g. In particular, in embodiments where a lead-carbon nanofiber composite material of the present disclosure is formed as an anode, the lead-carbon nanofiber composite material anode maintains about 25% or greater, about 30% or greater, about 35% or greater, about 40% or greater, or about 45% or greater of its capacity after about 50 or more, about 100 or more, about 150 or more, or about 200 or more cycles at 200 mA/g.

Having described the invention in detail, it will be apparent that modifications and variations are possible without departing from the scope of the invention defined in the appended claims.

### EXAMPLES

The following non-limiting examples are provided to further illustrate the present disclosure.

### Example 1

FIG. 4 illustrates one procedure of the present disclosure.

A first electrospinning solution is prepared by dissolving PbO particles (i.e the source of lead) and polyvinylpyrrolidone (PVP) in acetic acid. The PVP (i.e. first polymer) serves as a sacrificing material to deliver PbO. The first electrospinning solution further comprises a first solvent dimethylformamide (DMF).

A second electrospinning solution is prepared comprising the carbon nanofiber precursor polymer polyacrylonitrile (PAN) (i.e. the second polymer) dissolved in DMF (i.e. the second solvent).

The first and second electrospinning solutions are then separately extruded onto a drum collector, with the application of high voltage to the electrospinning tips. In certain configurations, the drum collector may rotate. Rotation may help ensure that the extruded solutions are evenly distributed.

The fibers resulting from electrospinning the first and second electrospinning operation are then removed from the drum collector and subjected to a heating (i.e. stabilizing) step at 270° C. As illustrated in FIG. 4, this heating step results in the PVP melting and transferring of the PbO metal particles on the fibers comprising the carbon nanofiber precursor polymer (PAN). This resulting material is described elsewhere herein as an intermediate fiber material.

The intermediate fiber material is then subjected to a final carbonization step. Carbonization takes place at 800° C. in an inert environment and/or in an environment that has been purged with nitrogen. Carbonization of the intermediate fiber material results in the lead-carbon nanofiber composite material. The lead-carbon nanofiber composite material has the PbO renucleated on the carbonized PAN.

### Example 2

Testing was conducted on lead-carbon nanofiber composite materials prepared in accordance with the procedures of Example 1.

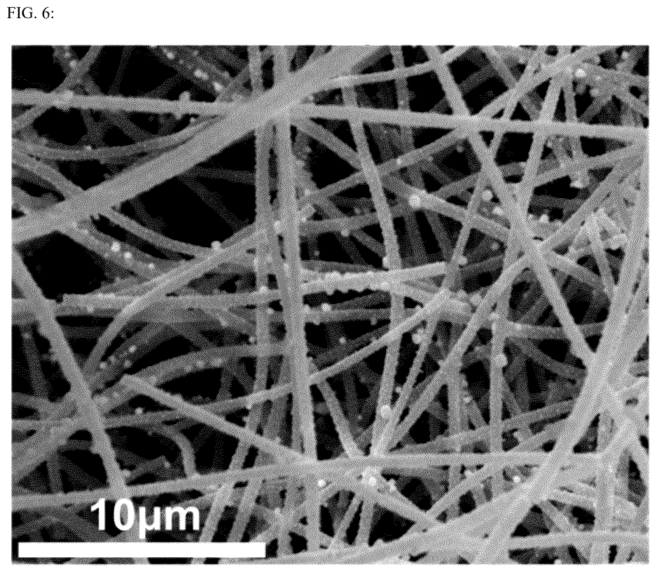

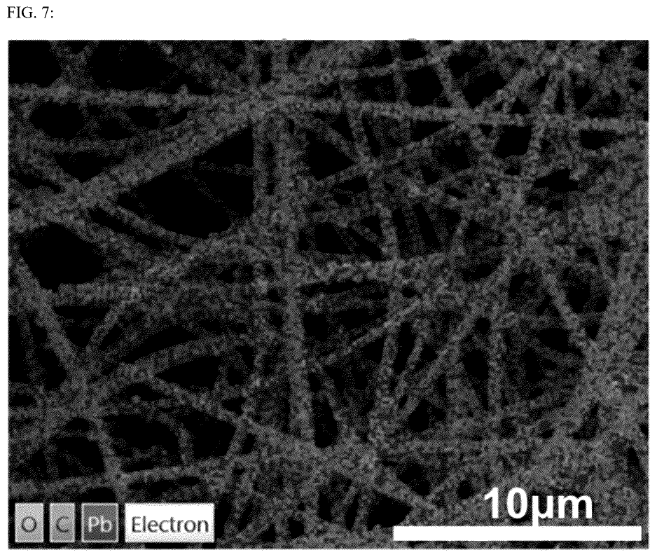

FIGS. 5 and 6 show a scanning electron microscope (SEM) image of the lead-carbon nanofiber composite material of the present disclosure.

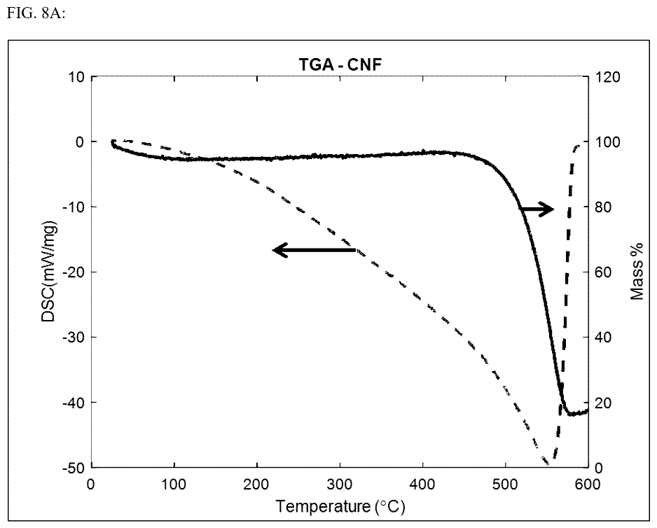

FIG. 7 further contrasts the image of FIG. 6 to show the elemental concentrations of O, C, and Pb in the lead-carbon nanofiber composite material.

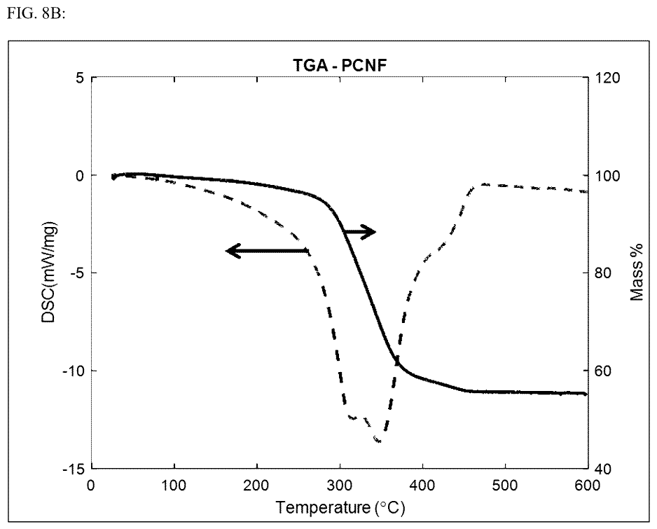

Thermogravimetric analysis was then conducted to compare a pure carbon nanofiber (CNF) sample and the lead-carbon nanofiber composite of Example 1. The analysis revealed a notable difference in residual mass between the pure carbon nanofiber (CNF) sample and the lead-carbon nanofiber composite materials when analyzed over a temperature range of 25-600° C. As shown in FIG. 8A, pure CNF exhibits the lowest residual mass, consistent with its primarily carbonaceous composition, which undergoes complete thermal decomposition or oxidation to CO₂ within this range, leaving minimal residue. In contrast, the lead-carbon nanofiber composite demonstrates a significantly higher residual mass (as shown in FIG. 8B), indicating the incorporation of thermally stable lead or lead-containing compounds. These non-volatile components remain in the residue after the carbon matrix decomposes, confirming the successful incorporation of lead into the composite. The magnitude of the residual mass directly correlates with the lead content, with higher residuals suggesting increased lead loading. This result underscores the presence of lead within the composite and validates the preparation methodology employed to achieve its integration.

### Example 3

Next, an experiment was conducted to test the specific capacity of the lead-carbon nanofiber composite material of Example 1, when prepared as a pouch cell in a lead-acid battery.

The lead-carbon nanofiber composite material was cut and prepared as a pouch cell against a lead anode with 0.5 M H₂SO₄ as the electrolyte. The test was conduct to show the performance of the lead-carbon nanofiber composite material as a cathode cycling at 100 mA/g.

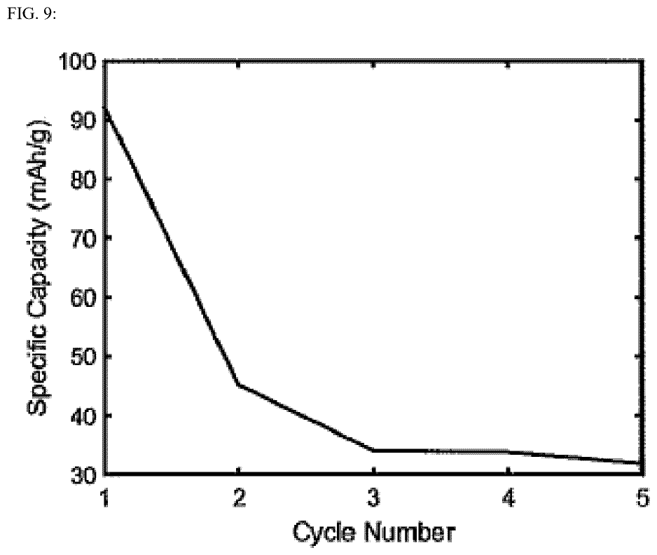

In the first cycle, the capacity was 92 mAh/g. This capacity quickly diminished with increased cycling. The results are reported in FIG. 9.

While the stability of the system demonstrated need for improvement, these results indicated the viability of a lead-carbon nanofiber composite material as a cathode for lead-acid batteries.

### Example 4

The lead-carbon nanofiber composite material of Example 1 was next tested to determine the performance of a lithium ion battery anode.

Samples of the lead-carbon nanofiber composite material were cut into disks for use as anodes and tested as half cells against Li foil.

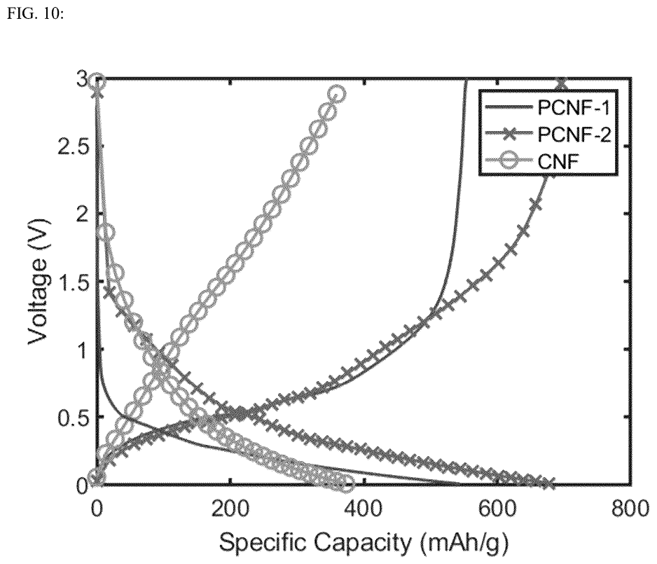

FIG. 10 shows a performance comparison between the lead-carbon nanofiber composite materials and pure nanofiber (CNF) cycling at 200 mA/g for a total of 250 cycles. The pure nanofiber was prepared in the same way as the lead-carbon nanofiber composite material, but without the addition of PbO.

As demonstrated by FIG. 10, the lead-carbon nanofiber composite material showed not only a higher capacity over pure carbon nanofiber but also marked stability over numerous cycles.

### Example 5

An experiment was next conducted to compare lead-carbon nanofiber composite material prepared at different voltages and flowrates during the electrospinning.

Sample “PCNF-1” was prepared using a higher voltage (25 kV) and flow rate (1 mL/hr) during electrospinning. Sample “PCNF-2” was prepared using a lower voltage (15 kV) and flow rate (0.5 mL/hr) during electrospinning. These samples were tested against a pure carbon nanofiber sample with no PbO-“CNF.”

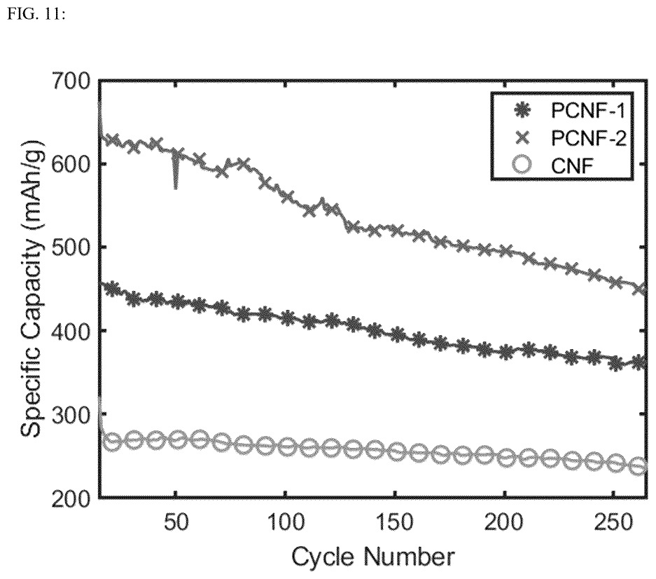

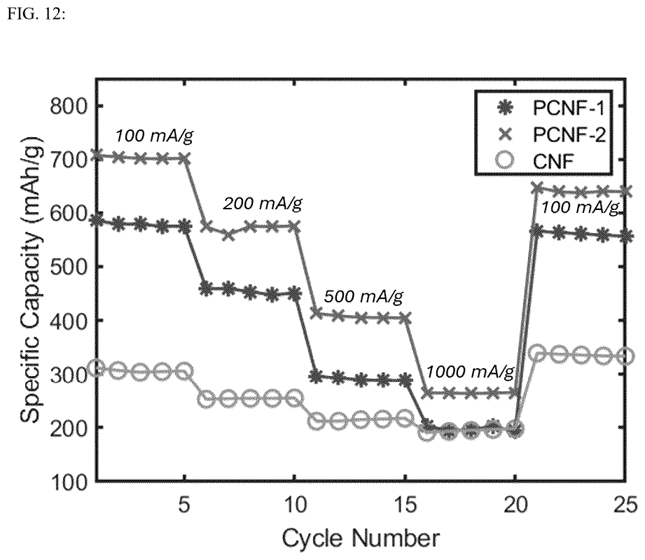

The materials were then used as an anode in a lithium-ion battery and tested. The cycling performance is reported in FIG. 11. The C-rate performance is reported in FIG. 12.

After 20+ cycles, the PCNF-2 specific capacity was found to be 364 mAh/g, as compared to 235 mAh/g for CNF. PCNF-2 showed only a 23% capacity degradation, as compared to PCNF-1 which showed a 41% decrease. Overall, PCNF-2 was found to show the best high current performance.

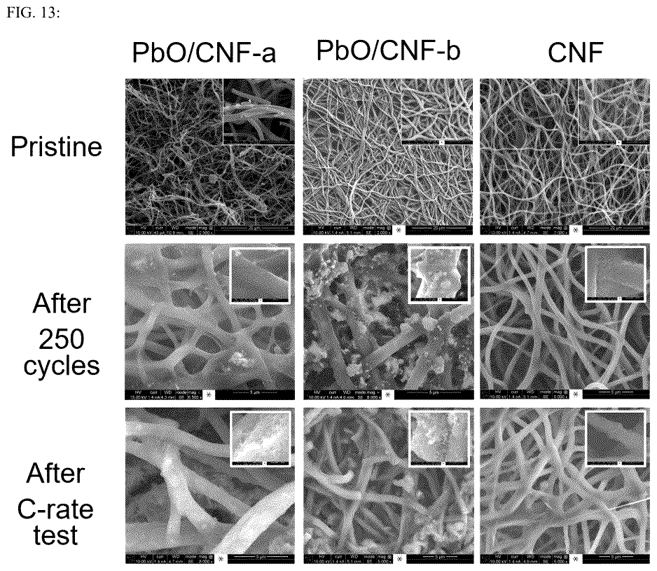

FIG. 13 reports the physical characteristics of each sample after 250 cycles and after a C-rate test.

After 250 cycles, the volume of PCNF-1 increased 121%, the volume of PCNF-2 increased 129%, and the volume of CNF increased 50%.

After the C-rate tests, the volume of PCNF-1 increased 309%, the volume of PCNF-2 increased 95%, and the volume of CNF increased 81%.

Generally, for Li-ion batteries, volume expansion is associated with mechanical degradation, which ultimately causes performance losses in batteries. However, battery performance can be preserved when the material has mechanical properties that can accommodate volume expansion without mechanically degrading the material. The results of this experiment demonstrate that, despite volume expansion as compared to pure nanofiber, the PCNF-1 and PCNF-2 samples accommodated (i.e. minimized) the volume expansion without substantial mechanical degradation. This indicates that the materials may be particularly suitable for application in a battery, even when exhibiting volume expansion.

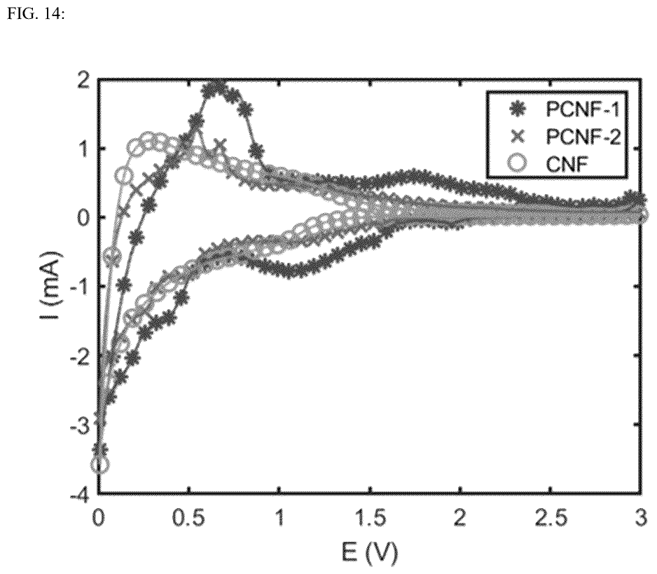

Cyclic-voltammetry analysis was also conducted, the results of which is reported in FIG. 14.

PCNF-1 and PCNF-2 showed a peak at about 0.3V. Peaks at low voltage for either cathodic (bottom) or anodic (top) curves were found to be associated with higher volume expansion.

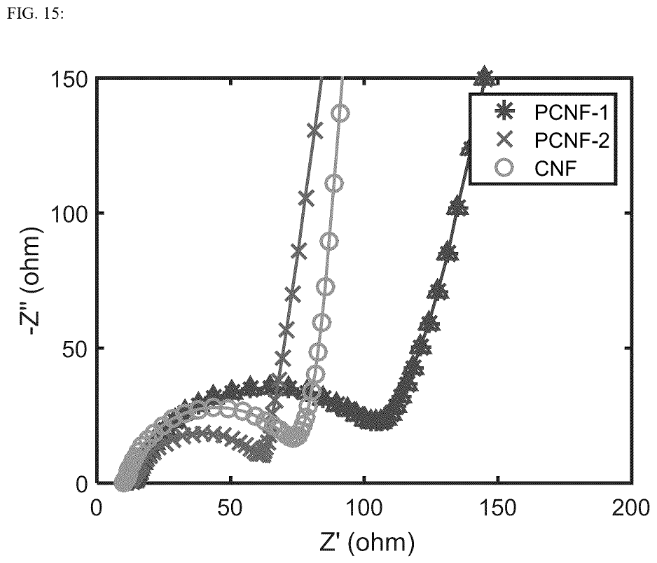

Next, electrochemical impedance spectroscopy (EIS) analysis was conducted. The results are reported in FIG. 15.

PCNF-2 showed the lowest impedance. The results demonstrated facile charge transfer as compared to CNF.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above methods, compositions, solutions, and materials without departing from the scope of the disclosure, it is intended that all matter contained in the above description and shown in the accompanying drawings shall be interpreted as illustrative and not in a limiting sense.

What is claimed is:

1. A method for preparing a metal-carbon nanofiber composite material, the method comprising:
providing a first solution comprising a source of metal and an acid;
providing a second solution comprising a first polymer and a first solvent;
combining the first solution and second solution to form a first electrospinning solution;
providing a second electrospinning solution comprising a second polymer and a second solvent;
electrospinning the first electrospinning solution and second electrospinning solution onto the same surface to produce a fiber material, wherein electrospinning each solution comprises an extrusion needle and a voltage source adjacent to the tip of the needle;
heating the fiber material to a temperature greater than the melting point of the first polymer to produce an intermediate fiber material; and
carbonizing the intermediate fiber material to produce a metal-carbon nanofiber composite material.

2. The method of claim 1, wherein the metal is lead and the source of lead comprises a lead oxide.

3. The method of claim 1, wherein the acid comprises acetic acid.

4. The method of claim 1, wherein the first polymer and second polymer are the same or different.

5. The method of claim 1, wherein the first polymer comprises polyvinyl pyrrolidone (PVP).

6. The method of claim 1, wherein the second polymer is a carbon nanofiber precursor comprising polyacrylonitrile.

7. The method of claim 1, wherein the first solvent and second solvent are the same or different.

8. The method of claim 1, wherein the first solvent comprises dimethylformamide (DMF).

9. The method of claim 1, wherein the second solvent comprises dimethylformamide (DMF).

10. The method of claim 1, wherein electrospinning the first electrospinning solution and second electrospinning solution comprises supplying, from the voltage source, a voltage of from about 10 kV to about 50 kV, from about 10 kV to about 45 kV, from about 10 kV to about 40 kV, from about 10 kV to about 35 kV, from about 10 kV to about 30 kV, from about 15 kV to about 30 kV, or from about 15 kV to about 25 kV to the tip of the needle.

11. The method of claim 1, wherein the first electrospinning solution and second electrospinning solution are extruded at the same volumetric rate.

12. The method of claim 1, wherein the first electrospinning solution and second electrospinning solution are extruded from separate extrusion needles.

13. The method of claim 12, wherein the voltage supplied to the needle extruding the first electrospinning solution is the same or different from the voltage supplied to the needle extruding the second electrospinning solution.

14. The method of claim 1, wherein heating the fiber material comprises heating the fiber material to a temperature of about 100° C. or greater, about 150° C. or greater, about 200° C. or greater, about 250° C. or greater, about 300° C. or greater, about 350° C. or greater, about 400° C. or greater, about 450° C. or greater, about 500° C. or greater, about 550° C. or greater, or about 600° C. or greater.

15. The method of claim 1, wherein heating the fiber material comprises heating the fiber material to a temperature of from about 100° C. to about 600° C., from about 150° C. to about 600° C., from about 200° C. to about 600° C., from about 250° C. to about 600° C., from about 250° C. to about 550° C., from about 250° C. to about 500° C., from about 250° C. to about 450° C., from about 250° C. to about 400° C., or from about 250° C. to about 350° C.

16. The method of claim 1, wherein carbonizing the intermediate fiber material comprises heating the intermediate fiber material to a temperature of about 500° C. or greater, about 600° C. or greater, about 700° C. or greater, about 800° C. or greater, about 900° C. or greater, about 1,000° C. or greater, about 1,100° C. or greater, about 1,200° C. or greater, about 1,300° C. or greater, about 1,400° C. or greater, or about 1,500° C. or greater for a period of about 15 minutes or greater, about 30 minutes or greater, about 45 minutes or greater, about 1 hour or greater, about 2 hour or greater, about 3 hour or greater, about 4 hour or greater, or about 5 hour or greater.

17. The method of claim 1, wherein carbonizing the intermediate fiber material comprises placing the intermediate fiber material in a heater and incrementally increasing the temperature at a rate of about 1° C./min, about 2° C./min, about 3° C./min, about 4° C./min, about 5° C./min, about 10° C./min, about 15° C./min, about 20° C./min, or about 25° C./min and heating the intermediate fiber material at a constant temperature of about 800° C. for a period of about 15 minutes or greater, about 30 minutes or greater, about 45 minutes or greater, about 1 hour or greater, about 2 hour or greater, about 3 hour or greater, about 4 hour or greater, or about 5 hour or greater.

18. A lead acid battery or lithium-ion battery comprising an anode material comprising the metal-carbon nanofiber composite material of claim 1.

19. The lead acid battery or lithium-ion battery of claim 18, wherein the metal-carbon nanofiber composite material anode maintains about 25% or greater, about 30% or greater, about 35% or greater, about 40% or greater, or about 45% or greater of its capacity after about 50 or more, about 100 or more, about 150 or more, or about 200 or more cycles at 200 mA/g.

20. The lead acid battery or lithium-ion battery of claim 18, wherein after about 50 or more cycles, about 100 or more cycles, about 150 or more cycles, or about 200 or more cycles at 200 mA/g the volume of the metal-carbon nanofiber composite material anode is about 150% or less, about 125% or less, about 120% or less, about 115% or less, about 110% or less, about 105% or less, or about 100% or less of the volume of the metal-carbon nanofiber composite material anode prior to the first cycle.
